(19) United States
(12) Patent Application Publication
(10) Pub. No.: US 2014/0299105 A1
(43) Pub. Date: Oct. 9, 2014

(54) Methods for Low Temperature Combustion and Engines Using the Same

(71) Applicant: Deyang Hou, Sugar Land, TX (US)

(72) Inventor: Deyang Hou, Sugar Land, TX (US)

(73) Assignee: QuantLogic Corporation, Sugar Land, TX (US)

(21) Appl. No.: 14/235,186

(22) PCT Filed: Jul. 27, 2012
(86) PCT No.: PCT/US12/48728

§ 371 Date: Jun. 26, 2014

Related U.S. Application Data
(60) Provisional application No. 61/512,382, filed on Jul. 27, 2011.

(51) Int. Cl. F02D 41/34

(52) U.S. Cl. CPC F02D 41/345
USPC 123/478

(57) ABSTRACT

This invention discloses a method for low temperature combustion using at least two fuels with low and high boiling points being directly injected into engine combustion chamber separately and sequentially with two different spray patterns, wherein the low boiling point fuel can be quickly vaporized to form a low temperature zone for containing fuel jet combustion of high boiling point fuels. An internal combustion engine using the disclosed low temperature combustion method is also provided.

### CROSS REFERENCE TO RELATED APPLICATION

This application is the National Stage Entry of PCT/US12/48728, which is based upon and claims the benefit of priority of U.S. Provisional Applications No. 61/512,382 filed on Jul. 27, 2011. The priority of U.S. Provisional Application No. 61/512,382 is claimed herein.

### BACKGROUND OF THE INVENTION

1. Field of the Invention

The present invention relates to combustion methods, devices, and an internal combustion engine using the same, either compression ignition or spark ignition internal combustion engines.

2. Description of the Related Art

While the engine industries have put great efforts for Homogenous Charge Compression Ignition (HCCI) and Premixed Charge Compression Ignition (PCCI) PCCI combustion, the conventional multi-hole fuel injectors limits the operation ranges of HCCI and PCCI. The major reasons are attributed to the fixed injection angle and dense jet nature of conventional multi-jet fuel sprays. The non-homogenous nature of the liquid multi-jet fuel jets under combustion environment, which was well documented by Dec [10], produce many challenges for emission reductions and ignition timing control. It would be ideal if we can find methods and devices which can make the jet have more homogenous equivalence ratios. Since currently HCCI or PCCI can only operate in low to medium loads in practical applications, conventional fixed-area nozzle designs have to be compromised for low and high loads. A large spray angle for high loads will bring severe wall (cylinder liner) wetting issues for early injections dictated by HCCI/PCCI mixture formation requirements. Such a fixed-spray angle and spray pattern nature is also hard to be adaptive for injecting different fuels in the same engine at different injection timings. A fixed narrow spray angle optimized for premixing will generate more soot formation for high loads. Thus, a variable spray angle and penetration is much better positioned to solve this contradiction between requirements for different injection timings and operation loads. This invention has solved this wall-wetting issue through using a variable spray angle, which is smaller for early injection and becomes larger for late injection, and a variable spray pattern, which is soft hollow conical mist-like spray for early injection with less penetration strength, and becomes multi-jet for late injection with higher penetration strength. This variable spray angle and pattern strategy can also be applied to direct injecting different fuels with different boiling points at different timings. One of such a variable spray fuel injector was documented in U.S. patent application Ser. No. 10/597,000 and No. 61/393,359. Other designs and discussion for variable spray patterns can be found in references [1-9].

Mixture formation is most critical for PCCI combustion. The essential feature of PCCI is ‘premixed charge’, thus the in-cylinder equivalence ratio distribution is the most critical factor deciding engine emissions and performance. Current practices indicated that only low to moderate loads are practical to deploy HCCI or PCCI due to difficulty in controlling the combustion starting point and pressure rising rates. Thus, an effective method to control the combustion reaction rate, especially control the rate during engine compression cycle, is important to extend the HCCI or PCCI operation maps.

Advantages of Low Temperature Combustion for diesel engines have been widely studied [11-14, 20, 21]. Researchers are well understood the limitations of low temperature combustion to light to medium load and impact to fuel economy through the traditional EGR and injection timing control approach. Recently, many researchers have turned to the use of oxygenated fuels [11, 15-17], especially ethanol, to break through the high smoke barrel of traditional EGR approach for enabling advanced low temperature combustion modes.

Increased level of EGR will reduce the in-cylinder oxygen level significantly that excess smoke may occur. The smoke is usually mitigated by increasing the boost pressure and increased fuel injection pressure. Researchers have demonstrated that intake port injection of ethanol can significantly reduce engine smoke or PM. Prof. Reitz and his team demonstrated reactivity controlled compression ignition (RCCI) for heavy-duty Engine operation at mid to high loads with diesel and ethanol fuels [17]. In their study, a port fuel injector was used to introduce liquid ethanol (E85) into the intake manifold of a single cylinder research diesel engine.

Reitz's strategy of direct-injection of a more reactive fuel (diesel) and port fuel injection of a less reactive fuel (gasoline ethanol blends) has improved the charge preparation. Operation with greater than 50% thermal efficiency while meeting EPA 2010 heavy duty emissions mandates has been demonstrated with acceptable pressure rise rate [17-19]. With E85 port fuel injection, it was demonstrated that the EGR rate required for meeting US EPA 2010 emissions are lower than that from other kinds of port fuel supplement. PM emissions are the lowest with ethanol injection. It was also reported that the lower EGR rates were found to be beneficial to increasing thermal efficiency, with the maximum efficiency measured to be 59% on a gross indicated basis. This study has demonstrated that with E85 injection via intake port, it is possible to optimize the injection strategy for low to high load conditions while meeting ultra low emissions.

The port injection method and blended fuel method of utilizing 1-butanol in diesel engines was investigated by Michikawauchi et al. [22]. The utilization of alcohol in diesel engines was shown to be a promising method of realizing a significant reduction in NO sub (x). It was shown that at high load the NO sub (x) reduction effect was 43% and 40% respectively, while at middle load the NO sub (x) reduction effect was 73% and 50% respectively. At low load, the thermal efficiency of both methods declined due to the unburned fuel loss, but in the blended fuel method the NO sub (x) could be reduced by 48% due to adding a cetane number improver. Following issues still need be further investigated:
Improvement of combustion at low loads—Port injection: reduction of unburned HC; blended fuel: improved ignition attribute (fuel properties, combustion system specifications)
Cold temperature and starting attributes of blended fuel;
Influence on fuel system parts and after-treatment system;
Robustness in regard to the alcohol ratio;

Event though the dual fuel combustion strategy through both port injections and in-cylinder direct injections reduced PM, NO sub (x), and improved fuel economy, all major previous work pointed to much higher CO and HC emissions, which put significant burden for after-treatment. The major reason for higher CO and HC is the port injection of the high volatile fuel, such as ethanol, methanol, liquid natural gas etc.

Thus, a method which can produce on-demand direct injection of both dual fuels would eliminate or reduce issues related to port injection of a ethanol or gasoline like volatile fuel, thus reduce HC, CO and improve cold starting capability, etc.

A summary of reference cited are listed as following:
[1] Hou, D., et al. A Micro-Variable Circular Orifice (MVCO) Fuel Injector for Zoned Low Temperature Combustion. DOE 2006 DEER Conference, Detroit, Mich., August 20-24.
[2] Hou, D., 2008 DEER Conference, ‘Enabling High Efficiency Clean Combustion with Micro-Variable Circular-Orifice (MVCO) Fuel Injector and Adaptive PCCI,’ Detroit, Mich., Aug. 4-7, 2008.
[3] Hou, D., A Mixed-Mode Fuel Injector with a Micro Variable Circular Orifice. PCT/IB2005/051474, 2005.
[4] Hou, D., China Patent No. ZL 2005 10200039.9.
[5] Hou, D., PCT/US10/41736.
[6] Hou, D., Huang, Y., Huo, M., Cheng, W. et al., “Spray and Atomization Characterization of a Micro-Variable Circular-Orifice (MVCO) Fuel Injector,” SAE Technical Paper 2011-01-0679, 2011, doi:10.4271/2011-01-0679.
[7] Hou, D. U.S. patent application 61/393,359
[8] Hou, D., et al, SAE paper 2009-01-1528
[9] Hou, D., PCT/US2008/067798, Premix Combustion Methods, Devices, and Engines Using the Same.
[10] Dec, J., SAE Paper 970873, 1997.
[11] Ford Motor, AVL, Ethanol Boosting Systems LLC, “Ethanol Optimized Engine,” USDA Biofuel Seminar Series, Mar. 29, 2011.
[12] Zhang, H., Kalish, Y., Allain, M., Zhu, G., and Han, Z., 2008 DEER Conference, Detroit, Mich., Aug. 4˜7, 2008.
[13] Zheng, M., Kumar, R., Fuel Efficiency Improvement of Low Temperature Combustion Diesel Engines, SAE Paper 2008-01-0841, 2008.
[14] Gurpreet Singh, Overview of the DOE Advanced Combustion Engine R&D, 2011 Annual Merit Review, DOE Vehicle Technology Program, Washington, D.C., May 9-13, 2011
[15] Magand, S., Lecointe, B., Chaudoye, F., Castagne, M., Optimization of a Euro 5 Vehicle Powered by an Ethanol Based Diesel Fuel, SAE Paper 2010-01-1520
[16] Cole, R., Poola, R., Sekar, R., Schaus, J., Mcpartlin, P., Effects of Ethanol Additives on Diesel Particulate and NO sub (x) Emissions, SAE Paper 2001-01-1937
[17] Splitter, D., Hanson, R., Kokjohn, S., Reitz, R., Reactivity Controlled Compression Ignition (RCCI) Heavy-Duty Engine Operation at Mid- and High-Loads with Conventional and Alternative Fuels, SAE paper 2011-01-0363
[18] Kokjohn, S., Hanson, R., Splitter, D., Reitz, R., Experiments and Modeling of Dual-Fuel HCCI and PCCI Combustion Using In-Cylinder Fuel Blending, SAE Paper 2009-01-2647
[19] Hanson, R., Kokjohn, S., Splitter, D., Reitz, R., An Experimental Investigation of Fuel Reactivity Controlled PCCI Combustion in a Heavy-Duty Engine, SAE Paper 2010-01-0864
[20] Lewander, C., Johansson, B., and Tunestal, P., “Extending the Operating Region of Multi-Cylinder Partially Premixed Combustion using High Octane Number Fuel,” SAE Technical Paper 2011-01-1394, 2011, doi:10.4271/2011-01-1394
[21] Stanton, D., “Potential Efficiency Impacts of HECC”, Engine Stretch Efficiency Colloquium at USCAR, Mar. 3, 2010.
[22] Michikawauchi, R., Tanno, S., Ito, Y., and Kanda, M., “Combustion Improvement of Diesel Engine by Alcohol Addition—Investigation of Port Injection Method and Blended Fuel Method,” SAE Technical Paper 2011-01-0336, 2011, doi:10.4271/2011-01-0336.

### SUMMARY OF THE INVENTION

Low Temperature Combustion (LTC) has proven to be effective for lowering engine out emissions and improving engine efficiency. However, currently LTC strategies heavily rely on exhaust gas recirculation (EGR) to control pressure rise rate. While heavy ERG is effective for reducing NO sub (x) formation and controlling combustion rate, it does bring several counter productive effects, such as tendency of high smoke level at high engine loads, fuel economy penalty, power density limitations, and turbo lags etc. An innovative method for enabling LTC without above drawbacks is critical for advancing the art of LTC for downsized high efficiency clean engines.

A novel method which can directly reduce the fuel jet flame temperature while increasing lift-off length is contemplated for enabling lean LTC. The new approach, referred as Adaptive Low Temperature Combustion Method with Jet Cooling, leverages two distinct spray patterns of hollow conical sprays and conventional multiple jets. The small penetration homogenous hollow conical sprays, which are supplied with a low boiling point liquid such as ethanol or water, form a conical or half-spherical well contained Low Temperature Zone (LTZ) in chamber space on-demand. This enables the multiple diesel-like fuel jets to pass through the LTZ without first ignition, thus form lean low equivalence ratio jets with increased lift-off lengths. The fuel jets are burned in a much dispersed and controlled manner with low temperature. Thus it eliminates the key sources of NO sub (x) and PM formation and reduces thermal loss. Since fuel injection system can provide much faster response according to engine speeds and loads, the proposed method provides much faster response compared to exhaust gas recirculation (EGR). It can significantly reduce the engine out emissions, and enhance the engine efficiency and adaptability without sacrificing power density.

The proposed Adaptive Low Temperature Combustion Method with Jet Cooling can be applied to both compression ignition engines and spark ignition engines. The focus of this presentation is on direct injection compression ignition. An efficiency-harvesting injection in expansion stroke to harvest the waste energy is also disclosed with a adaptive dual-fuel injector. Thus, the Adaptive Low Temperature Combustion Method with Jet Cooling and the adaptive dual-fuel injector could be effective enabling technologies and advance the art for high efficiency low emission engines.

By introducing fuel both with early injection and late injection with adaptive means in the same power cycle, we can produce an adaptive low temperature mixed-mode combustion. In the adaptive PCCI, early PCCI is used to generate in-cylinder radicals to accelerate diffusion combustion and reduce NO sub (x), while accelerated diffusion combustion is used to consume CO and HC produced by PCCI and stabilize combustion.

### BRIEF DESCRIPTION OF THE DRAWINGS

FIG. 1 is a side view of said hollow conical spray (13) pattern; ‘a’ is half conical spray angle;

FIG. 2 is a side view of multi-jet spray (14) pattern;

FIG. 3 is a top view of a sequential overlap of multi-jet and hollow conical spray patterns; 11—cooled multi-jet sprays, 12—low temperature zone formed by hollow conical spray; multi-jets (11) pass through the low temperature zone (12) formed by dispersed hollow conical sprays;

FIG. 4(a) is an illustration of the spray pattern variations along with injection timings; spray patterns can be varied from hollow conical spray to multi-jet sprays; 41—hollow conical spray with small spray angle 2a; 42—hollow conical spray with larger spray angle 2b; 43—multi-jet spray with larger spray angle 2c;

FIG. 4(b) is an illustration of the spray pattern variations along with injection timings; spray patterns can be varied from small angle multi-jet sprays to large angle multi-jet sprays; 41—multi-jet sprays with small spray angle 2a; 42—multi-jet sprays with larger spray angle 2b; 43—main multi-jet spray with larger spray angle 2c;

FIG. 5(a) is an exemplary internal combustion engine embodiment based on said combustion methods with early injection shown; 51—fuel injector with a variable orifice, such as shown in FIG. 8; 52—hollow conical spray for low boiling point fuel, 53-combustion chamber surface, 54—piston, 55—cylinder, 56—cylinder head;

FIG. 5(b) is an exemplary internal combustion engine embodiment based on said combustion methods with late injection shown; 57—multi-jet spray for high boiling point fuel with larger spray angle matched with combustion chamber;

FIG. 6(a) is an exemplary internal combustion engine embodiment based on the combustion methods with early injection shown; 51—duel fuel injector(s), 52—small angle multi-jet sprays for low boiling point fuel, 53—combustion chamber surface, 54-piston, 55—cylinder, 56—cylinder head;

FIG. 6(b) is an exemplary internal combustion engine embodiment based on the combustion methods with late injection shown; 57—multi-jet spray for high boiling point fuels with larger spray angle matched with combustion chamber;

FIG. 7 is an illustration of low temperature dual-mode combustion method enabled by dual fuel direct injections. 71 is major heat release from low boiling point fuels, 72 is major heat release from high boiling point fuels, 7C is the centroid of heat releases.

FIG. 8 is an illustration of one embodiment of one injector design capable of delivering dual fuels with variable spray patterns of hollow conical sprays and multi-jet sprays with different spray angles as disclosed in U.S. Provisional Patent Application No. 61/393,359. As disclosed in U.S. Application 61/393,359, such a variable orifice fuel injector comprising:

(i) a nozzle body comprising passages for pressured fuel, an inner cylindrical bore for receiving two longitudinally displaceable coaxial needle valves with an outward opening inner needle valve which is moving away relative to nozzle body large end to reach opening position, and an inward opening outer needle valve which is moving toward nozzle body large end to reach opening position, fuel outlets in said nozzle body, and two seal surfaces on said nozzle body with a seal surface which provides sealing for said inward opening needle valve to block fuel, and another seal surface which provides sealing for said outward opening needle valve and guidance for fuel path, at least one spring which urges said two coaxial needle valves into biased seating positions to block fuel, and a valve block to hold control valves, and
(ii) said outward opening needle valve which has means to inject fuel into combustion chamber in a hollow conical spray pattern through annular fuel outlet when it is displaced from seating position to opening positions, and
(iii) said inward opening needle valve which has means to inject fuel into combustion chamber in conventional multiple jet spray patterns through fuel outlets when it is lifted from seating position to opening positions;
Where in, said variable orifice fuel injector has means to inject different fuels in different hollow conical spray patterns and conventional multiple jet spray patterns selectively and independently.

### DESCRIPTION OF THE PREFERRED EMBODIMENTS

### Statement A:

A low temperature combustion method, which is mainly for internal combustion engines, comprising steps of: (i) setting fuel injection timings and fuel quantities based on engine speeds and loads, (ii) directly injecting at least two types of fuels separately and sequentially into the same combustion chamber, with fuel bearing lower boiling point being injected first with smaller spray angles and smaller penetrations when engine piston is away from engine top dead center, and fuels bearing higher boiling point being introduced subsequently with larger spray angles when piston is closer to engine top dead center, wherein the early introduced fuels being vaporized to form a well contained lower temperature zones to partially contain fuel jets with higher boiling points to produce low temperature combustion.

### Statement B:

A low temperature combustion method of Statement A, wherein the fuel bearing lower boiling point being injected first with smaller spray angles and smaller penetrations in hollow conical sprays when engine piston is away from engine top dead center, and fuels bearing higher boiling points being introduced subsequently with larger spray angles and multi-jet spray patterns when piston is closed to engine top dead center.

### Statement C:

A low temperature combustion method of Statement A, wherein the fuel bearing lower boiling point being injected first with smaller spray angles and smaller penetrations in small multi-jets when engine piston is away from engine top dead center, and fuels bearing higher boiling point being introduced subsequently with larger spray angles and larger multi-jet sprays when piston is closed to engine top dead center.

A combustion method of Statement A, wherein the fuels with lower boiling points are coupled with lower injection pressure, and fuels with higher boiling points are coupled with higher injection pressure, wherein the different fuel pressure levels are provided by at least one of the following means including different cam profiles, different pressure common rail reservoirs, or local pressure amplification inside injectors.

A combustion method of Statement A, wherein the multiple fuels are introduced by a single variable orifice fuel injector per engine cylinder.

A combustion method of Statement A, wherein the smaller fuel jets and larger fuel jets are introduced by at least two separate fuel injectors providing different spray angles per engine cylinder.

A combustion method of Statement A, wherein the fuels with lower boiling points are at least one of ethanol fuels, gasoline fuels, liquefied natural gas, and the fuels with higher boiling points are at least one of diesel fuels, bio-diesel fuels.

A combustion method of Statement A, wherein the fuel with lower boiling point is bearing high contents of water, and the fuels with higher boiling points are at least one of diesel fuels, bio-diesel fuels.

A combustion method of Statement A, wherein the fuels with lower boiling points are at least one of water, water and fuel solutions, ethanol fuels, liquefied natural gas, and the fuels with higher boiling points are at least one of diesel fuels, bio-diesel fuels, gasoline fuels.

A combustion method of Statement A, wherein it has a spray angle approximately between 50˜120 degree for injecting said low boiling point fuels, and a spray angle of approximately between 120˜150 degree for injecting said high boiling point fuels.

A combustion method of Statement B, wherein it has single early injection or a plural number of early injections with injection conducted approximately between 120˜30 degree before TDC with hollow conical sprays having smaller angles, and at least one main fuel injection conducted approximately between −5˜30 degree after TDC, preferably starting at 0˜15 degree crank angle after TDC with larger multi-jet sprays having larger spray angles.

A combustion method of Statement C, wherein it has single early injection or a plural number of early injections with injection conducted approximately between 120˜30 degree before TDC with smaller multi-jets having smaller spray angles, and at least one main fuel injection conducted approximately between −5˜30 degree after TDC, preferably starting at 0˜15 degree crank angle after TDC with larger multi-jet sprays having larger spray angles;

An internal combustion engine using the said combustion method of Statement A, wherein there is at least one injection of at least one low boiling point fuel before TDC, wherein there is at least one injection of at least one high boiling point fuel around TDC.

An internal combustion engine of Statement A, wherein there is at least one injection of at least one low boiling point fuel before engine TDC, at least one injection of at least one high boiling point fuel before engine TDC but after the low boiling point fuel injection, and at least one injection of at least one high boiling point fuel around TDC.

An internal combustion engine using at least one fuel injector, which can be a spark-ignition engine or a compression-ignition engine, where in it has means to inject dual fuels with different spray patterns at different injection timings, preferably with first type of fuel injected in hollow conical spray patterns for earlier injections which is away from engine top dead center (TDC), and at least one main fuel injection with a second type of fuel injected in conventional multiple jets around TDC, and one optional late injection which is away from TDC with second type of fuel in hollow conical spray patterns with first type of fuel.

An internal combustion engine of Statement A, wherein there is at least one injection of at least one low boiling point fuel before engine TDC, at least one injection of at least one high boiling point fuel before engine TDC, and at least one injection of at least one high boiling point fuel around TDC, and at least another injection of at least one low boiling point fuel after TDC in the expansion stroke.

An internal combustion engine of Statement A, wherein there is at least one injection of at least one low boiling point fuel before engine TDC, and at least one injection of at least one the high boiling point fuel around TDC, and at least another injection of at least one low boiling point fuel after TDC in the expansion stroke.

An internal combustion engine of claim 14, further have at least another injection of water after engine top dead center (TDC) in the expansion stroke to generate in-cylinder steam to gain more work.

An internal combustion engine of Statement A, wherein the said crank angle of the centroid of heat releases from smaller jets and larger jets falls approximately between 5˜20 degree after TDC, and the heat releases resemble a separated twin triangular-like shapes;

An internal combustion engine of Statement A, has following integrated features: when engine is idle, it only injects fuels with high boiling points around engine top dead center (TDC); for said engine at low to medium engine loads, with approximately 10˜50% of total fuel dose injected as earlier fuel injection(s) approximately between 100˜30 degree crank angle (CA) before TDC, and the rest of the fuel injected approximately between −5˜40 degree after TDC, preferably starting between 0˜15 degree after TDC; for said engine at above medium to full engine loads, fuel is injected in the similar manner but with more fuel quantity of approximately 50˜80% injected as earlier injection(s) with low boiling point fuels;

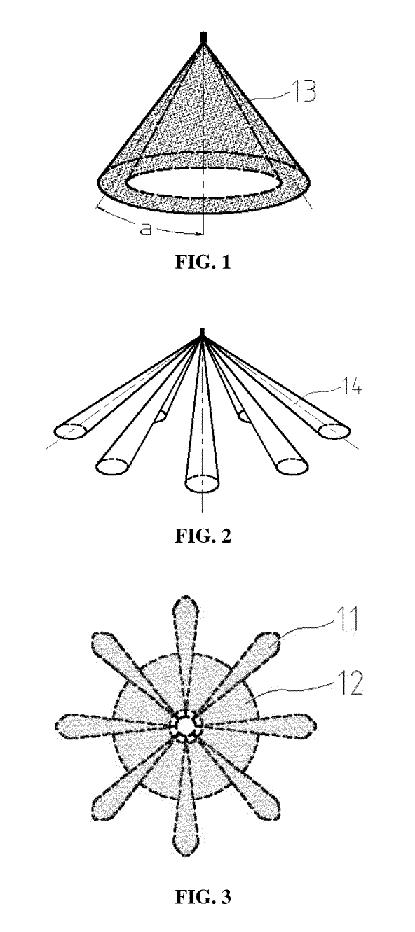

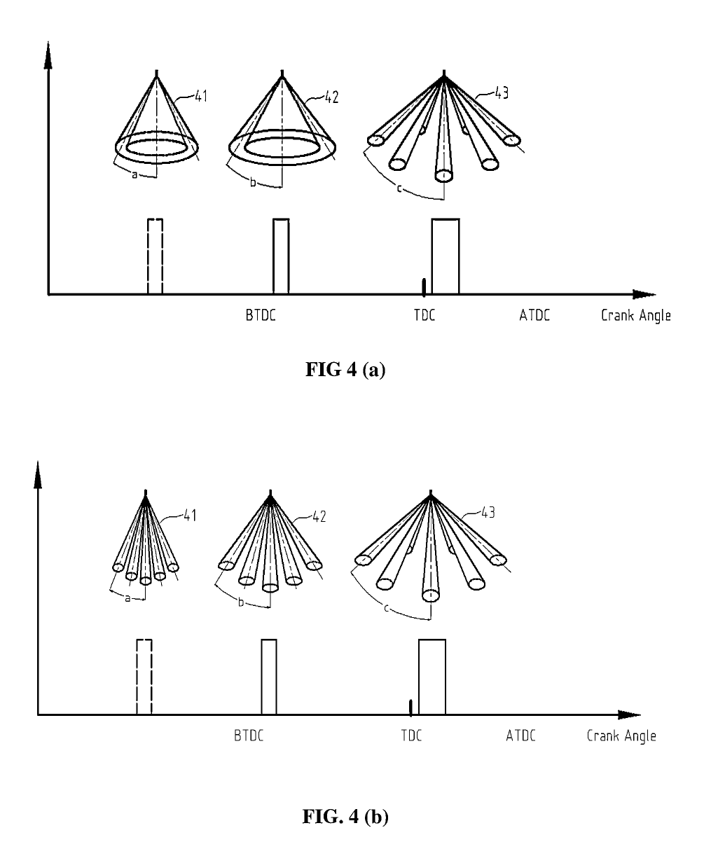

As shown in FIG. 4, the spray patterns can vary along with injection timings; spray patterns can be varied from hollow conical spray with small angle, to multi-jet sprays with larger angles, as shown in FIG. 1 & FIG. 2;

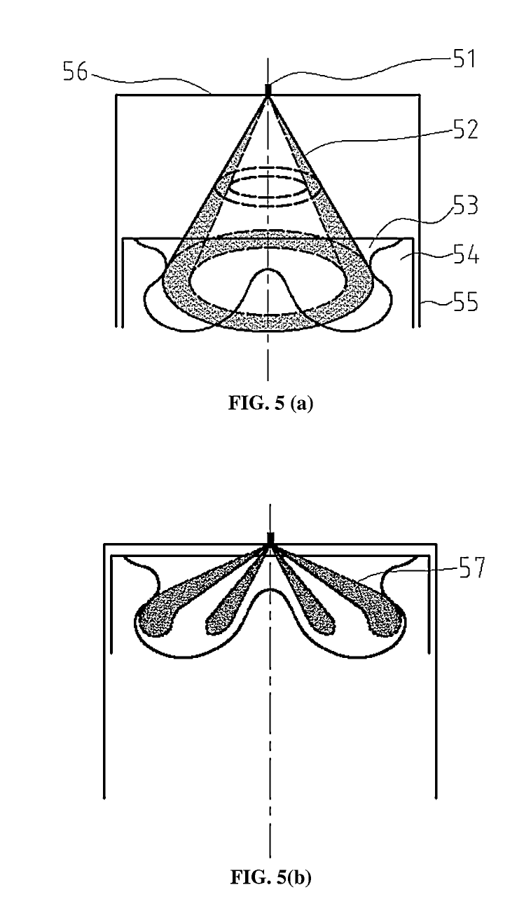

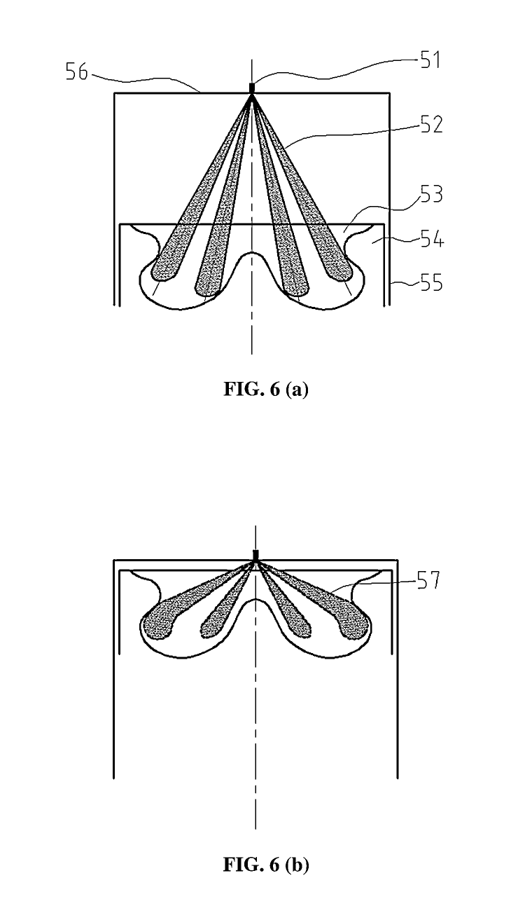

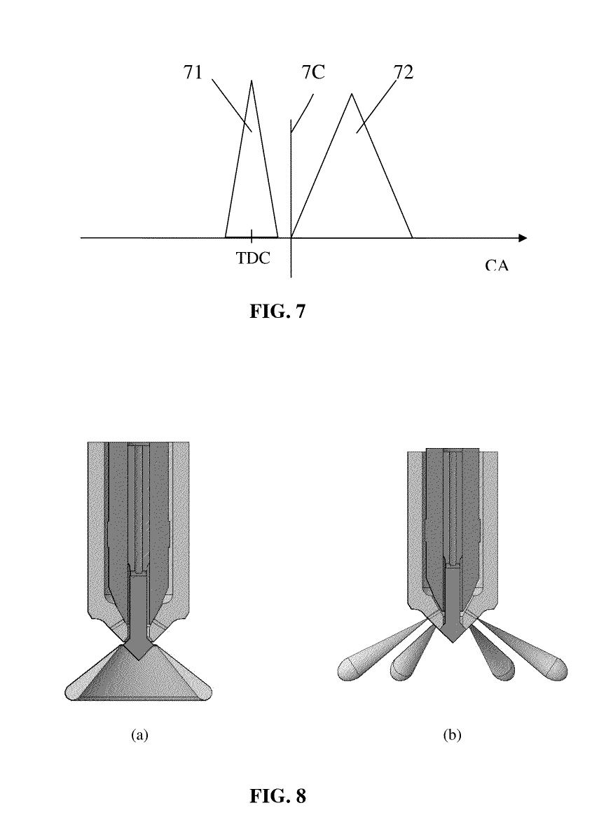

FIG. 5 is an exemplary internal combustion engine embodiment based on said combustion methods with early injection shown. The spray pattern is hollow conical, the spray angle is small, preferably in the range of 50100 degree.

In one exemplary internal combustion engine using said Low Temperature Combustion method, has following integrated features:
a. for said engine at low loads, with approximately 0˜30% of total fuel dose is low boiling point fuels being injected with earlier fuel injection(s) with hollow conical sprays with smaller spray angles between 50 to 120 degree approximately between 100˜50 before top dead center (BTDC), and the rest of the fuel dose is high boiling point fuel being injected with larger jets with larger spray angles between 120 to 150 degree proximately between −5˜40 degree after top dead center (ATDC), preferably starting between 0˜15 degree ATDC;
b. for said engine at medium loads, with approximately 30˜60% of total fuel dose is low boiling point fuels being injected with earlier fuel injection(s) with hollow conical sprays with smaller spray angles between 50 to 120 degree approximately between 100˜50 BTDC, and the rest of the fuel dose is high boiling point fuel being injected with larger multi-jets with larger spray angles between 120 to 150 degree proximately between −5˜40 degree ATDC, preferably starting between 0˜15 degree ATDC;
c. for said engine at above medium to full engine loads, fuel is injected in the similar manner as (a) but with more fuel percentage of approximately 50˜80% of low boiling point fuel injected as earlier injection(s), wherein the percentage decreases along with increased loads;
d. having a variable orifice fuel injector with 6 to 10 larger holes having larger spray angles;
e. Said engine has an exhaust gas recirculation (EGR) ratio approximately between 5˜60%, depending on engine loads, with lower loads tend to have higher EGR ratios.
f. wherein it has a compression ratio approximately in the range of 14˜18, and a low swirl ratio approximately in the range of 0˜1.5;

In another exemplary internal combustion engine using said combustion method, has following integrated features:
a. for said engine at low loads, with approximately 0˜30% of total fuel dose is low boiling point fuel being injected as earlier injection with a nozzle having hole diameter approximately 70˜120 micron meter within 100˜50 degree BTDC, and the rest of the fuel is high boiling point fuel being injected approximately between −5˜40 degree ATDC, preferably starting injection at 0˜15 degree ATDC with a separate larger nozzle having hole diameters approximately 100250 micron meter, depending on engine bore diameters;
b. for said engine at low to around medium loads, with approximately 30˜60% of total fuel dose is low boiling point fuel being injected as earlier injection with a nozzle having hole diameter approximately 70˜120 micron meter within 100˜50 degree BTDC, and the rest of the fuel is high boiling point fuel being injected approximately between −5˜40 degree ATDC, preferably starting injection at 0˜15 degree ATDC with a separate larger nozzle having hole diameters approximately 100˜250 micron meter, depending on engine bore diameters;
c. for said engine at above medium to full engine loads, fuel is injected in the similar manner as (a) but with high fuel percentage of approximately 50˜80% low boiling point fuel being injected as earlier injection(s);
d. said engine has a lower swirl ratio preferably between 0˜1.5, a preferred compression ratio of 14 to 18;
e. said engine has a nozzle with 6˜10 larger holes with larger spray angles approximately 120˜150 degree for injecting high boiling point fuels, and a separate nozzle with 6˜20 smaller holes with smaller spray angles approximately 60˜120 degree for injecting low boiling point fuels. The two separate nozzles are mounted in the same engine cylinder;
f. said engine has an exhaust gas recirculation (EGR) ratio approximately between 5˜60%, depending on engine loads, with lower loads tend to have higher EGR ratios.

The fuel dosing ratios between low boiling point and high boiling points fuels are not very critical except the engine loads are at high end and low end of loads to ensure within ignition limits and engine running smoothness. However, the injection timings are critical for each low and high boiling point fuels.

What is claimed is:

1. A low temperature combustion method, which is mainly for internal combustion engines, comprising steps of: (i) setting fuel injection timings, fuel types and fuel quantities based on engine speeds and loads, (ii) directly injecting at least two types of fuels separately into the same combustion chamber, wherein fuel bearing lower boiling point being injected first with smaller spray angles when engine piston is away from engine top dead center (TDC), and fuels bearing higher boiling point being injected subsequently with larger spray angles when piston is closer to engine top dead center, wherein the early injected fuels being vaporized to form a well contained lower temperature zones to partially contain fuel jets with higher boiling points to produce low temperature combustion.

2. A low temperature combustion method of claim 1, wherein the fuel bearing lowest boiling point being injected first with smaller spray angles and smaller penetrations in hollow conical sprays when engine piston is away from engine top dead center (TDC), and fuels bearing higher boiling points being introduced subsequently with larger spray angles and multi jet spray patterns when piston is closed to engine TDC.

3. A low temperature combustion method of claim 1, wherein the fuel bearing lower boiling point being injected first with smaller spray angles and smaller penetrations in small multi jets when engine piston is away from engine top dead center (TDC), and fuels bearing higher boiling point being introduced subsequently with larger spray angles and larger multi jet sprays when piston is closed to engine TDC.

4. A combustion method of claim 1, wherein the fuels with lower boiling points are coupled with lower injection pressure, and fuels with higher boiling points are coupled with higher injection pressure, wherein the different fuel pressure levels are provided by at least one of the following means including different cam profiles, different common rail reservoirs with different pressure, or pressure amplification devices inside injectors.

5. A combustion method of claim 1, wherein the multiple fuels are introduced by a single variable orifice fuel injector per engine cylinder.

6. A combustion method of claim 1, wherein the low boiling point fuels and high boiling point fuels are injected by at least two separate fuel injectors providing different spray angles per engine cylinder.

7. A combustion method of claim 1, wherein the fuels with lower boiling points are at least one of ethanol fuels, gasoline fuels, liquefied natural gas, and the fuels with higher boiling points are at least one of diesel fuels, bio-diesel fuels.

8. A combustion method of claim 1, wherein the fuel with lower boiling point is bearing high contents of water, and the fuels with higher boiling points are at least one of diesel fuels, bio-diesel fuels.

9. A combustion method of claim 1, wherein the fuels with lower boiling points are at least one of water or water solutions, ethanol fuels, liquefied natural gas, and the fuels with higher boiling points are at least one of diesel fuels, bio-diesel fuels, gasoline fuels.

10. A combustion method of claim 1, wherein it has a spray angle approximately between 50˜120 degree for injecting said low boiling point fuels, and a spray angle of approximately between 120˜150 degree for injecting said high boiling point fuels.

11. A combustion method of claim 2, wherein it has single early injection or a plural number of early injections with injection conducted approximately between 120˜30 degree before engine top dead center (TDC) with hollow conical sprays having smaller angles, and at least one main fuel injection conducted approximately between −5˜30 degree after TDC, preferably starting at 0˜15 degree crank angle after TDC with larger multi-jet sprays having larger spray angles;

12. A combustion method of claim 3, wherein it has single early injection or a plural number of early injections with injection conducted approximately between 120˜30 degree before engine top dead center (TDC) with smaller multi jets having smaller angles, and at least one main fuel injection conducted approximately between −5˜30 degree after TDC, preferably starting at 0˜15 degree crank angle after TDC with larger multi-jet sprays having larger spray angles;

13. An internal combustion engine using the said combustion method of claim 1, wherein there is at least one injection of at least one low boiling point fuel before TDC, wherein there is at least one injection of at least one high boiling point fuel around TDC.

14. An internal combustion engine using the said combustion method of claim 1, wherein there is at least one injection of at least one high boiling point fuel around TDC.

15. An internal combustion engine of claim 13, wherein there is at least one injection of at least one low boiling point fuel before engine top dead center (TDC), at least one small quantity injection of at least one high boiling point fuel before engine TDC but after the low boiling point fuel injection, and at least one major injection of at least one high boiling point fuel around TDC.

16. An internal combustion engine of claim 14, further have at least another injection of at least one low boiling point fuel after engine top dead center (TDC) in the expansion stroke.

17. An internal combustion engine of claim 14, further have at least another injection of water after engine top dead center (TDC) in the expansion stroke to generate in-cylinder steam to gain more work.

18. An internal combustion engine of claim 13, wherein there is at least one injection of at least one low boiling point fuel before engine top dead center (TDC), and at least one injection of at least one high boiling point fuel around TDC, and at least another injection of at least one low boiling point fuel after TDC in the expansion stroke.

19. An internal combustion engine of claim 13, wherein the said crank angle of the centroid of heat releases from smaller jets and larger jets falls approximately between 5˜20 degree after TDC, and the heat releases resemble a separated twin triangular-like shapes;

20. An internal combustion engine of claim 13, has following integrated features:
(a) When engine is idle, it only injects fuels with high boiling points around engine top dead center (TDC);
(b) for said engine at low to medium engine loads, with approximately 10˜50% of total fuel dose injected with low boiling point fuel as earlier fuel injection(s) approximately between 100˜30 degree crank angle (CA) before TDC, and the rest of the fuel injected with high boiling point fuels approximately between −5˜40 degree after TDC, preferably starting between 0˜15 degree after TDC;
(c) for said engine at above medium to full engine loads, fuel is injected in the similar manner as (b) above but with more fuel quantity of approximately 50˜80% injected as earlier injection(s) with low boiling point fuels;
